(19) United States
(12) Patent Application Publication
(10) Pub. No.: US 2013/0199139 A1
(43) Pub. Date: Aug. 8, 2013

(54) FILTER AND METHOD FOR THE PRODUCTION THEREOF

(71) Applicant: Adam Krueger, Leutkirch (DE)

(72) Inventor: Adam Krueger, Leutkirch (DE)

(73) Assignee: SPHEREFIL GMBH, Leutkirch (DE)

(21) Appl. No.: 13/574,534

(22) PCT Filed: Dec. 21, 2010
(86) PCT No.: PCT/EP2010/007832

§ 371 Date: Oct. 23, 2012

(30) Foreign Application Priority Data
Jan. 22, 2010 (DE) 10 2010 005 583.2
May 19, 2010 (DE) 10 2010 020 924.4

(51) Int. Cl. B01D 46/52; B01D 46/00

(52) U.S. Cl. CPC B01D 46/521; B01D 46/0001
USPC 55/482; 55/521; 55/498; 493/379; 493/344; 493/384

(57) ABSTRACT

A filter, in particular a pocket filter for filtration in air systems and devices, comprises at least one filter pocket, which is formed by folding a filter medium. A method for producing a filter, in particular a pocket filter for filtration in air systems and devices, comprises forming at least one filter pocket by folding a filter medium over a self-contained folding edge. A filter, in particular a pocket filter for filtration in air systems and devices, is also provided, which comprises a filter pocket made of a filter medium, wherein the filter pocket is self-contained and wave-shaped.

The invention relates to a filter, in particular a pocket filter for filtration in air systems and devices, comprising at least one filter pocket which is formed by folding a filter medium. The invention also relates to a method for producing said filter.

A generic filter is known, for example, from WO 01/02078 A1.

Due to extensive sewing work, the production of customary pocket filters is rather elaborate. In addition, the filter area per footprint of the filter, i.e. per area of the inlet port of the filter, is relatively small.

The invention is based on the object to simplify the production of such a filter and at the same time to increase the filter area per footprint of the filter.

The object basing the invention is solved by a method for producing a filter, in particular a pocket filter for filtration in air systems and devices, comprising at least one filter pocket which is formed by folding a filter medium, wherein the filter pocket is formed by folding the filter medium over a self-contained folding edge. Any change in the plane of extent of the filter medium, regardless of whether in an acute or an obtuse angle, is called a folding. The folding edge formed by such folding does not mandatorily form a sharp burr; the radius of curvature of the filter medium in the region of the folding edge may have any size and preferably ranges between 0.1 mm to 10 mm. A folding edge is said to be self-contained when it has neither a beginning nor an end. Thus, the entire filter area of the filter according to the invention can be made by one cut-out. By folding the filter medium over the self-contained folding edge, the filter medium can be given a three-dimensional, self-supporting and dimensionally stable structural design which is at the same time also very compact. This may result in the following functional advantages: The effective filter area per footprint of the filter, or per filter cell (no seam reduction/no frame reduction) and the inherent rigidity of the filter medium can be increased strikingly with regard to conventional solutions. Minor incident flow differences or less overcoming of the differential pressure can be obtained in the view due to missing frame area and broader “free passage openings”. The flow-through of the filter medium can be optimized. Misfits in wrong positions are also no longer possible. Beyond that, economical advantages might also arise: Compared to conventional solutions, the production and disposal costs can be reduced strikingly and the lifetimes can be increased strikingly. Altogether, the air systems and the devices for which the filter according to the invention is used reveal strikingly improved energy balances.

In a preferred embodiment of the invention, preferably before the filter medium is being folded, at least one of the following steps is performed:
Tailoring the filter medium, preferably by cutting the filter medium when in a flat state, preferably by cutting the filter medium (2) substantially in the form of a circular segment;
Transferring the filter medium into a three-dimensional state, preferably to form a body in the form of either a cylinder, a cone, a truncated cone, a polyhedron, a truncated polyhedron, a cuboid, a prism, a pyramid or a truncated pyramid, or the like, wherein the body is preferably sack-shaped and provided with an aperture;
Fixing the filter medium in a three-dimensional state, preferably by sewing, preferentially by sewing two edges of the filter medium with each other.

In another preferred embodiment of the invention, preferably after the filter medium has been folded, at least one of the following steps is performed:
Positioning the filter medium in a frame having a passage opening, so that said passage opening is preferably entirely covered by said filter medium;
Fixing said filter medium to the frame;
Sealing said filter medium with regard to the frame;
Fixing said filter medium to a supporting device, preferably in the region of at least one folding edge.

Each of said steps serves to strikingly reduce the production efforts with regard to conventionally used solutions. The order of the steps is not mandatory.

It may be helpful to have at least one filter pocket produced in wave-shaped manner by folding the filter medium over the self-contained folding edge. Related to the footprint of the filter, such a filter pocket shape provides an especially large filter area. Beyond that, said filter pocket shape is especially compact, self-supporting and dimensionally stable, so that the filter pocket walls can be kept at a distance even when a fluid to be filtered is flowing therethrough. Thus, the flow resistance of the filter and the energy input of the system can be reduced strikingly.

It may be advantageous to have the filter medium being alternately folded in different directions over at least two self-contained folding edges. Owing to such folding in different directions, said structural design is exceptionally compact, self-supporting and dimensionally stable. Thus, the flow resistance of the filter and the energy input of the system can still be further reduced strikingly.

Another independent aspect of the invention relates to a filter, in particular a pocket filter for filtration in air systems and devices, comprising a filter pocket made of a filter medium, wherein the filter pocket is self-contained and wave-shaped. The above-mentioned advantages can be obtained by means of said filter pocket form.

In a preferred embodiment of the invention, the filter medium meets at least one of the following requirements:
The filter medium is a textile planar material, preferably a textile composite material, preferentially woven fabrics, crocheted fabrics, knitted fabrics, nettings, nonwoven fabrics, felts, or the like.
The filter medium includes fibers and/or yarns made of cellulose, glass, metal and/or plastic material, preferably polyester or viscose, or mixtures thereof.
The filter medium has an areal density ranging between 5 and 400 g/m², preferably between 10 and 200 g/m², preferentially between 20 and 100 g/m².
When in the folded state, the filter medium is self-supporting and/or dimensionally stable.
The filter medium has been hardened either thermally, chemically and/or mechanically.
The filter medium has been smoothed on at least one side, preferably on both sides.

To make use of all filter media may be conceivable, in particular to make use of filter media as they are used for the production of filter pockets. This means that in the coarse dust region or in filter grades G3 and G4 and in the fine dust region or in filter grades F5 to F9 it can be worked with both synthetic fiber and glass fiber materials and media on a paper and foil base. Combinations of the materials as mentioned, e.g. melt-blown media where two or more different media layers are arranged one after the other, are also conceivable. Furthermore, filter media made of glass fibers without connective fabrics (e.g. paint stop mats) or synthetic fiber coarse dust mats without connective fabrics are also conceivable. The advantage of such structural design is that it can alternatively be used in suction or injection openings which are provided in channels. Advantageous for the filter medium is the filtration characteristic according to DIN EN 779 as well as the bending flexibility required to obtain the structural design as described.

In yet another advantageous embodiment of the invention, the filter includes at least one self-contained folding edge which meets at least one of the following requirements:
The filter medium forms an acute angle over the folding edge.
The folding edge either depicts a circle, a rectangle, a rounded rectangle, a square, an ellipse, a circular segment, a polygon, a rounded polygon, or the like.
The folding edge lies in a plane.
At least two folding edges lie in the same plane.
At least two folding edges lie in different planes.
At least two folding edges are arranged coaxially with respect to each other.
At least two folding edges are arranged concentrically with respect to each other.
The circumferential lengths of the folding edges increase from the inside to the outside preferably in a straight proportional manner.

In yet still another advantageous embodiment of the invention, the filter includes at least one filter pocket which meets at least one of the following requirements:
At least one of the filter pocket walls is formed as the mantle either of a cylinder, a cone, a truncated cone, a polyhedron, a truncated polyhedron, a cuboid, a prism, a pyramid or a truncated pyramid, or the like.
The filter pocket walls form an acute angle.

In yet still another advantageous embodiment of the invention, the filter includes at least two self-contained, wave-shaped filter pockets which meet at least one of the following requirements:
The filter pockets are arranged one into the other.
The filter pockets are substantially arranged concentrically.
The filter pockets are substantially arranged coaxially.
The filter pockets are substantially of the same height.
The filter pockets are of different heights, the heights of said filter pockets either increasing or decreasing preferably from the inside to the outside.

In yet still another advantageous embodiment of the invention, the filter includes a frame which meets at least one of the following requirements:
The frame surrounds the filter medium in circumferential direction at least section-wise, preferably entirely.
The frame is self-contained.
The frame is either of circular, elliptic, polygonal, preferably rectangular or square form.
The frame is substantially either made of plastic, metal and/or cellulosic materials, in particular wood, paper or paperboard.
The frame has a substantially hollow, preferably L-, C-, S-, W-, H-, U-shaped cross-sectional profile.
The frame includes a passage opening for the fluid to be filtered, the filter medium preferably covering the entire passage opening so that a fluid entering said passage is inevitably conducted through the filter medium.
The frame is connected to the filter medium either in a permanently fixed or in a detachable manner, preferably material bonded, form-fitted and/or force-locked.
The frame is sealed with regard to the filter medium.

The frame consists preferably of profiles made either of plastic, metal or sheet metal, wood, paperboard and/or PUR. The frame can be provided with a sealing so as to make it tight with re- gard to the system when in use.

In yet still another advantageous embodiment of the invention, the filter includes a supporting device which meets at least one of the following requirements:
The supporting device is mounted to the frame, preferably either in a permanently fixed or in a detachable manner.
The supporting device extends at least section-wise, preferably entirely, over the passage opening.
The supporting device extends substantially transversely to the folding edge.
The supporting device extends substantially in one plane.
The supporting device includes at least one restiform supporting element which preferably has either been designed as a wire, a cord, a rope, a tube, a hose, a rod, a bar, or the like.
The supporting device includes a plurality of restiform supporting elements extending in different directions over the passage opening.
The supporting device has been designed as a mesh-wire fabric.
The supporting device contacts the filter medium, preferably in the region of the folding edge, preferentially in a corner region of the folding edge.
The supporting device is connected to the filter medium either in a permanently fixed or in a detachable manner, preferably material bonded, form-fitted and/or force-locked.

Preferred developments thereof can be obtained by combining the features of the sub-claims or partial aspects thereof.

### SHORT DESCRIPTION OF THE DRAWINGS

FIG. 1 is a schematic, perspective view of an embodiment of the filter according to the invention.

FIG. 2 is a sectional view of II-II according to FIG. 1.

FIG. 3 is a view of a tailored filter medium for use in the method for producing a filter according to the invention.

### DETAILED DESCRIPTION OF THE PREFERRED EMBODIMENTS

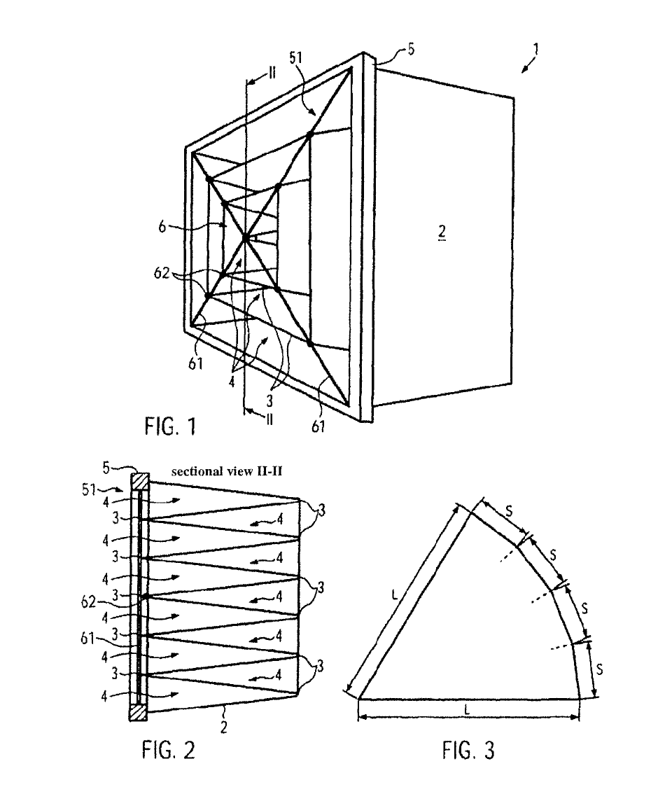

FIG. 1 is a schematic, perspective view of an embodiment of the filter 1 according to the invention, which has been designed as a pocket filter for filtration in air systems and devices. Filter 1 comprises a filter medium 2, at least one filter pocket 4, a frame 5 having a passage opening 51 and a supporting device 6 having two supporting wires 61. FIG. 2 is a sectional view II-II according to FIG. 1.

Filter medium 2 is preferably a break-proof non-woven polyester fabric of an area density ranging between 20 and 100 g/m², which has been hardened preferably thermally and smoothed on the side of the clean air. Filter medium 2 is folded alternately in different directions over a whole of five self-contained, concentric and substantially square folding edges 3 so as to obtain a three-dimensional, self-supporting, dimensionally stable state.

Two folding edges 3 lie substantially in the plane of passage opening 51; three further folding edges 3 lie outside thereof in a plane parallel to the plane of passage opening 51. Those folding edges 3 lying in one plane, respectively, are arranged concentrically with respect to each other. All folding edges 3 are arranged coaxially with respect to each other, i.e. the (imaginary) centers of folding edges 3 lie on one axis.

On the contaminated air side and on the clean air side of filter 4, three or two concentric, self-contained and ring wave-shaped filter pockets 4 of substantially the same height are formed by folding filter medium 2. In the present case, the walls of filter pockets 4 are substantially formed as mantles of truncated pyramids (without bottom and lid) and form an acute angle over folding edges 3, respectively. The wall of the innermost filter pocket 4 which is open towards the clean air side is designed as a pyramid mantle inside the innermost folding edge 3.

Square frame 5 includes a C-shaped cross-sectional profile of metal which is self-contained and surrounds filter medium 2 entirely in the circumferential direction. Frame 5 is permanently connected to filter medium 2 and sealed with regard to filter medium 2. Passage opening 51 is covered entirely by filter medium 2 so that a fluid entering passage opening 51 is inevitably guided through filter medium 2 and, thus, filtered.

Supporting device 6 includes two metal supporting wires 61 which are detachably fastened to frame 5 in a form-fitting manner and extend substantially in the plane of passage opening 51 between opposite corners of frame 5 so that supporting wires 61 cross each other in the center of passage opening 51. Folding edges 3 are bonded to supporting wires 61 at fixed points 62. Filter medium 2 is stretched between fixed points 62 so as to allow folding edges 3 to extend substantially linearly between fixed points 62.

Deviating from the description, filter medium 2 and/or folding edge 3 and/or folding pocket 4 and/or frame 5 and/or supporting device 6 can be designed at will in order to realize the teaching according to the invention.

In the following, the method according to the invention for producing filter 1 according to the invention will be described:

In a first step, filter medium 2 which is in a plane state is tailored by cutting. FIG. 3 shows a filter medium 2 substantially tailored in a circular segment form and having a side length L of 3.6 m. Deviating from the ideal circular segment form, four segments extending more or less tangentially to the (imaginary) circular arc and each having a segment length S of about 0.6 m are cut to shape instead of said circular arc.

In a second step, filter medium 2 is transferred from the plane state to a three-dimensional state to form a sack-like body in the form of a cone or a pyramid, the body including an opening at the end opposite to the tip.

In a third step, filter medium 2 is fixed in the three-dimensional state by sewing the two legs.

In a fourth step, filter medium 2 is folded preferably alternately in different directions over preferably a plurality of self-contained, concentric and substantially square folding edges 3 so as to form the preferably plurality of concentric, self-contained and wave-shaped filter pockets 4.

In a fifth step, filter medium 2 is arranged in a frame 5 including a passage opening 51 such that the opening of filter medium 2 and the passage opening 51 coincide with each other so that filter medium 2 covers passage opening 51 entirely. If necessary, filter medium 2 is fastened to frame 5 and sealed with regard to frame 5. Filter medium 2 can be positioned in supporting frame 5 without what is known as O-rings and intermediate frames, as the three-dimensionally folded filter medium 2 is self-supporting.

In a sixth step, filter medium 2 is fixed to a supporting device 6. It is just a cross of supporting wires 61 chucked between the frame corners by which the fixing points 62 of filter medium 2 are locked, as shown in FIG. 1.

At a side length L of 3.6 m and a segment length of 600 mm, filter medium 2 of filter 1 according to the invention has an overall filter area of approx. 4 m². Compared to a standard pocket filter with an overall filter area of 4.32 m² with six lines of 600 mm*600 mm and twelve individual pockets each having 575 mm*575 mm of filter area, there is a frame material saving of approx. 50%. Time savings of approx. 40% may also be scheduled, as the new structural design is achieved just by folding the filter medium 2 and fixing it in supporting frame 5 and at fixing points 62. To this end, a seam length of 300 cm of filter 1 according to the invention faces a seam length of 1080 cm in conventional pocket filters (180 cm per filter pocket of a total of 6 filter pockets).

1. A method for producing a filter, the method comprising:
forming a self-contained and wave-shaped filter pocket by folding a filter medium over a self-contained folding edge, wherein the folding edge depicts a polygon; and
fixing the filter medium to a supporting device having at least one restiform supporting element so that the restiform supporting element contacts the filter medium in a corner region of the folding edge.

2. The method according to claim 1, wherein, before the filter medium is folded, at least one of the following steps is performed:
a. tailoring the filter medium;
b. transferring the filter medium to a three-dimensional state;
c. fixing the filter medium in a three-dimensional state.

3. The method according to claim 1, wherein, after the filter medium has been folded, at least one of the following steps is performed:
a. positioning the filter medium in a frame having a passage opening, so that the passage opening is enirely covered by the filter medium;
b. fixing the filter medium to the frame;
c. sealing the filter medium with regard to the frame.

4. The method according to claim 1 wherein the filter medium is alternately folded in different directions over at least two self-contained folding edges.

5. A filter comprising;
a filter pocket which is formed by a filter medium, wherein the filter pocket is self-contained and wave-shaped, wherein the filter includes;
at least one self-contained folding edge depicting a polygon; and a supporting device having at least one restiform supporting element, wherein the restiform supporting element contacts the filter medium in a corner region of the at least one folding edge.

6. The filter according to claim 5, wherein the filter medium meets at least one of the following requirements:
a. the filter medium is a textile planar material;
b. the filter medium includes fibers and/or yarns made of cellulose, glass, metal and/or plastic material;
c. the filter medium has an areal density ranging between 5 and 400 g/m²;
d. when in the folded state, the filter medium is self-supporting and/or dimensionally stable;
e. the filter medium has been hardened either thermally, chemically and/or mechanically;
f. the filter medium has been smoothed on at least one side.

7. The filter according to claim 5 wherein the at least one folding edge meets at least one of the following requirements:
a. the filter medium forms an acute angle over the at least one folding edge;
b. the at least one folding edge depicts a circle, a rectangle, a rounded rectangle, a square, an ellipse, a circular segment, a polygon, or a rounded polygon;
c. the at least one folding edge lies in a plane;
d. the at least one folding edge comprises at least two folding edges that lie in the same plane;
e. the at least one folding edge comprises at least two folding edges that lie in different planes;
f. the at least one folding edge comprises at least two folding edges that are arranged coaxially with respect to each other;
g. the at least one folding edge comprises at least two folding edges that are arranged concentrically with respect to each other;
h. the at least one folding edge comprises multiple folding edges that each have a circumferential length, and the circumferential lengths of the folding edges increase away from a center of the filter.

8. The filter according to claim 5 wherein the filter pocket includes walls and meets at least one of the following requirements:
a. at least one of the filter pocket walls is formed as a mantle of a cylinder, a cone, a truncated cone, a polyhedron, a truncated polyhedron, a cuboid, a prism, a pyramid or a truncated pyramid;
b. the filter pocket walls form an acute angle.

9. The filter according to claim 5 wherein the filter includes at least two self-contained, wave-shaped filter pockets which meet at least one of the following requirements:
a. the at least two filter pockets include two filter pockets that are arranged one into the other;
b. the at least two filter pockets are substantially arranged concentrically;
c. the at least two filter pockets are substantially arranged coaxially;
d. the at least two filter pockets are substantially of the same height.
e. the at least two filter pockets have different heights.

10. The filter according to claim 5 further including a frame which meets at least one of the following requirements:
a. the frame surrounds the filter medium in a circumferential direction at least section-wise;
b. the frame is self-contained;
c. the frame is of circular, elliptic, polygonal, preferably rectangular or square form;
d. the frame is substantially made of plastic, metal and/or cellulosic material;
e. the frame has a substantially hollow, cross-sectional profile;
f. the frame includes a passage opening for a fluid to be filtered, wherein the filter medium covers the entire passage opening so that a fluid passing through said passage is inevitably conducted through the filter medium;
g. the frame is connected to the filter medium either in a permanently fixed or in a detachable manner;
h. the frame is sealed with regard to the filter medium.

11. The filter according to claim 5 wherein the supporting device meets at least one of the following requirements:
a. the filter includes a frame, and the supporting device is mounted to the frame;
b. the filter includes a frame that defines a passage opening for a fluid to be filtered, and the supporting device extends at least section-wise over the passage opening;
c. the supporting device extends substantially transversely to the at the at least one folding edge;
d. the supporting device extends substantially in one plane;
e. the at least one restiform supporting element is a wire, a cord, a rope, a tube, a hose, a rod, or a bar.
f. the supporting device includes a plurality of restiform supporting elements extending in different directions over the passage opening;
g. the supporting device is a mesh-wire fabric;
h. the supporting device is connected to the filter medium either in a permanently fixed or in a detachable manner.

12. The method according to claim 1 further comprising, before the filter media is folded, cutting the filter medium when in a flat state such that the filter medium is cut substantially in the form of a circular segment.

13. The method according to claim 1 further comprising, before the filter media is folded, transferring the filter medium to a three-dimensional state to form a sack-shaped body having an aperture.

14. The method according to claim 13 wherein the transferring step is performed such that the body is formed as a cylinder, a cone, a truncated cone, a polyhedron, a truncated polyhedron, a cuboid, a prism, a pyramid or a truncated pyramid.

15. The method according to claim 13 further comprising fixing the filter medium in the three-dimensional state by sewing together edges of the filter medium.
